(19) United States
(12) Patent Application Publication
(10) Pub. No.: US 2020/0364406 A1
(43) Pub. Date: Nov. 19, 2020

(54) ENTITY RELATIONSHIP PROCESSING METHOD, APPARATUS, DEVICE AND COMPUTER READABLE STORAGE MEDIUM

(71) Applicant: BAIDU ONLINE NETWORK TECHNOLOGY (BEIJING) CO., LTD, Beijing (CN)

(72) Inventors: Miao FAN, Beijing (CN); Yeqi BAI, Beijing (CN); Mingming SUN, Beijing (CN); Ping LI, Beijing (CN)

(73) Assignee: BAIDU ONLINE NETWORK TECHNOLOGY (BEIJING) CO., LTD, Beijing (CN)

(21) Appl. No.: 16/875,274

(22) Filed: May 15, 2020

(30) Foreign Application Priority Data
May 17, 2019 (CN) 2019104142894

(51) Int. Cl. G06F 40/295; G06F 40/284; G06N 3/08; G06K 9/62

(52) U.S. Cl. CPC G06F 40/295; G06K 9/6256; G06N 3/08; G06F 40/284

(57) ABSTRACT

An entity relationship processing method, an apparatus, a device and a computer readable storage medium are disclosed. In embodiments of the present disclosure, since a small amount of annotated data, namely, a small amount of annotated samples under some uncommon entity relationship classes are used, and segment features with a finer granularity are increased to characterize the to-be-processed text, it is possible to, based on the small amount of annotated samples of uncommon entity relationships, accurately predict uncommon entity relationships existing in the text, and thereby improve the recognition accuracy of the small amount of uncommon entity relationships.

### CROSS REFERENCE TO RELATED APPLICATIONS

The present application claims the priority of Chinese Patent Application No. 201910414289.4, filed on May 17, 2019, with the title of “Entity relationship processing method, apparatus, device and computer readable storage medium”. The disclosure of the above applications is incorporated herein by reference in its entirety.

### TECHNICAL FIELD

The present disclosure relates to entity relationship recognition technologies, and particularly to an entity relationship processing method, an apparatus, a device and a computer readable storage medium.

### BACKGROUND

An effective entity relationship recognition algorithm may help a machine to understand an internal structure of a natural language, and meanwhile it is an important means for expanding a knowledge base or supplementing a knowledge graph. A common drawback of a conventional entity relationship recognition algorithm is high dependency on a large amount of annotated data. Therefore, the above algorithm may produce relative higher recognition accuracy merely on a large number of common entity relationships, and may obtain relative lower recognition accuracy on a small number of uncommon entity relationships.

Therefore, it is desirable to provide an entity relationship processing method to improve the recognition accuracy of a small number of uncommon entity relationships.

### SUMMARY

Aspects of the present disclosure provide an entity relationship processing method, an apparatus, a device and a computer readable storage medium, to improve the recognition efficiency of a small number of uncommon entity relationships.

In an embodiment of the present disclosure, there is provided an entity relationship processing method, which includes: performing a feature extraction process on a to-be-processed text by using a first neural network, to obtain an initial feature vector of the text; performing a segmentation process on the text to obtain at least two segments of the text; performing a feature extraction process on each segment of the at least two segments of the text by using at least one second neural network, to obtain a feature vector of each segment of the text; obtaining an optimized feature vector of the text according to the initial feature vector of the text and the feature vector of each segment of the text; obtaining a first entity relationship class existing in the text by using a third neural network according to an optimized feature vector for each first entity relationship class in at least two first entity relationship classes and the optimized attire vector of the text.

In another embodiment of the present disclosure, there is provided an entity relationship processing apparatus, which includes: a first feature extracting unit configured to perform a feature extraction process on a to-be-processed text by using a first neural network, to obtain an initial feature vector of the text; a second feature extracting unit configured to perform a segmentation process on the text to obtain at least two segments of the text; and perform a feature extraction process on each segment of the at least two segments of the text by using at least one second neural network, to obtain a feature vector of each segment of the text; a feature processing unit configured to obtain an optimized feature vector of the text according to the initial feature vector of the text and the feature vector of each segment of the text: a relationship recognizing unit configured to obtain a first entity relationship class existing in the text by using a third neural network, according to an optimized feature vector for each first entity relationship class in at least two first entity relationship classes and the optimized feature vector of the text.

In an embodiment of the present disclosure, there is provided a device, which includes: one or more processors; a storage for storing one or more programs, the one or more programs, when executed by said one or more processors, enable said one or more processors to implement the above-mentioned entity relationship processing method.

In an embodiment of the present disclosure, there is provided a computer readable storage medium on which a computer program is stored, the program, when executed by a processor, implementing the above-mentioned entity relationship processing method.

As known from the above technical solutions, in embodiments of the present disclosure, it is feasible to perform a feature extraction process on a to-be-processed text by using a first neural network, to obtain an initial feature vector of the text, then perform a segmentation process on the text to obtain at least two segments of the text, then perform a feature extraction process on each segment of the at least two segments of the text by using at least one second neural network, to obtain a feature vector of each segment of the text, and then obtain an optimized feature vector of the text according to the initial feature vector of the text and the feature vector of each segment of the text, so that it is possible to obtain a first entity relationship class existing in the text by using the third neural network according to an optimized feature vector of each first entity relationship class in at least two first entity relationship classes and the optimized feature vector of the text. Since a small amount of annotated data, namely, a small amount of annotated samples under some uncommon entity relationship classes are used, and segment features with a finer granularity are increased to characterize the to-be-processed text, it is possible to, based on the small amount of annotated samples of uncommon entity relationships, accurately predict uncommon entity relationships existing in the text, and thereby improve the recognition accuracy of the small amount of uncommon entity relationships.

In addition, the technical solution according to the present disclosure does not need to depend on a large amount of annotated samples of the uncommon entity relationships, so that the costs of the annotated data may be substantially reduced upon model training, and meanwhile the stability of the model may be ensured.

In addition, with the technical solution according to the present disclosure, the recognition accuracy may be further improved by further introducing a triple loss function in addition to the cross entropy loss function in the model training phase.

In addition, the user's experience may be effectively improved according to the technical solution of the present disclosure.

### BRIEF DESCRIPTION OF THE DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1A is a flow chart of an entity relationship processing method according to an embodiment of the present disclosure;

FIG. 1B is a schematic diagram of a classification effect of using a cross entropy loss function for model training in an embodiment corresponding to FIG. 1;

FIG. 1C is a schematic diagram of a classification effect of using a cross entropy loss function and a triple loss function to perform model training in the embodiment corresponding to FIG. 1;

FIG. 2 is a structural schematic diagram of an entity relationship processing apparatus according to an embodiment of the present disclosure; and

FIG. 3 is a block diagram of an example computer system/server 12 adapted to implement an implementation mode of the present disclosure.

### DETAILED DESCRIPTION OF EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

It is to be noted that the terminals involved in the embodiments of the present disclosure include but are not limited to a mobile phone, a Personal Digital Assistant (FDA), a wireless handheld device, a tablet computer, a Personal Computer (PC), an MP3 player, an MP4 player, and a wearable device (e.g., a pair of smart glasses, a smart watch, or a smart bracelet).

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

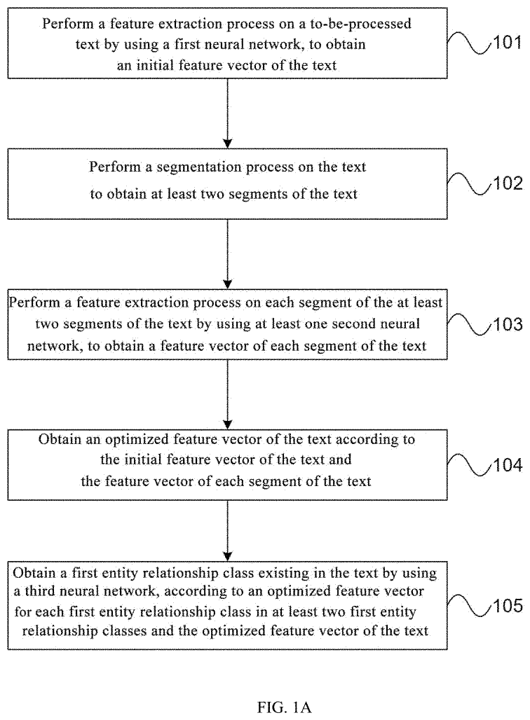

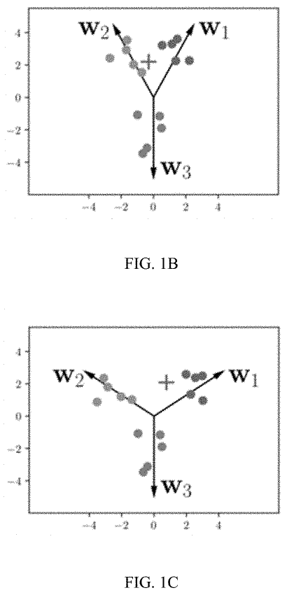

FIG. 1A is a flow chart of an entity relationship processing method according to an embodiment of the present disclosure. As shown in FIG. 1A, the method may include:

101: performing a feature extraction process on a to-be-processed text by using a first neural network, to obtain an initial feature vector of the text.

102: performing a segmentation process on the text to obtain at least two segments of the text.

103: performing a feature extraction process on each segment of the at least two segments of the text by using at least one second neural network, to obtain a feature vector of each segment of the text.

104: obtaining an optimized feature vector of the text according to the initial feature vector of the text and the feature vector of each segment of the text.

105: obtaining a first entity relationship class existing in the text by using a third neural network, according to an optimized feature vector of each first entity relationship class in at least two first entity relationship classes and the optimized feature vector of the text

The first neural network, the second neural network, or the third neural network may include, but is not limited to, a Recurrent Neural Network (RNN), a Convolutional Neural Network (CNN), or a deep neural network Network (DNN). This is not particularly limited in this embodiment.

It is to be noted that, some or all subjects for executing 101-105 may be an application located in a local terminal, or a function unit such as a plug-in or Software Development Kit (SDK) located in an application of the local terminal, or a processing engine located in a network-side server, or a distributed type system located on the network side. This is not particularly limited in this embodiment.

It may be understood that the application may be a native application (nativeAPP) installed on the terminal, or a web program (webApp) of a browser on the terminal. This is not particularly limited in this embodiment.

As such, it is possible to perform a feature extraction process on a to-he-processed text by using a first neural network, to obtain an initial feature vector of the text, then perform a segmentation process on the text to obtain at least two segments of the text, then perform a feature extraction process for each segment of the at least two segments of the text by using at least one second neural network, to obtain a feature vector of each segment of the text, and then obtain an optimized feature vector of the text according to the initial feature vector of the text and the feature vector of each segment of the text, so that it is possible to obtain the first entity relationship class existing in the text by using the third neural network, according to an optimized feature vector of each first entity relationship class in at least two first entity relationship classes and the optimized feature vector of the text. Since a small amount of annotated data, namely, a small amount of annotated samples under some uncommon entity relationship class are used, and segment features with a finer granularity are increased to characterize the to-be-processed text, it is possible to, based on the small amount of annotated samples of uncommon entity relationships, accurately predict uncommon entity relationships existing in the text, and thereby improve the recognition accuracy of the small amount of uncommon entity relationships.

In the present disclosure, an optimization process is performed for the feature extraction of the to-be-processed text, and segment features with a finer granularity are increased to characterize the to-be-processed text. Features of the entity having an uncommon entity relationship in the text may be effectively made outstanding by further using an innovative process of using a second neural network to perform the feature extraction on each segment in the text individually, in addition to using the current process of using a first neural network to perform the feature extraction on the text as a whole.

In the present disclosure, since a large number of annotated samples are employed when models (including, the first neural network, second neural network and third neural network) are built and the entity relationships (referred to as a second entity relationships) present therein is common entity relationships, it is possible to, during the prediction of the uncommon entity relationship existing in the to-be-processed text, use the built models, then employ a small amount of annotated samples having the uncommon entity relationship (referred to as a first entity relationship), and predict the entity relationship existing in the text by using a Few-shot Learning technology.

In the case where data (including corpus and corpus tags) is limited, the Few-shot Learning technology usually achieves a more ideal effect than a conventional supervised learning algorithm. The data of the Few-shot Learning consists of many paired Support. Sets and Query Sets. Each Support Set includes N classes (in the present invention, it is the recognized first entity relationship class) of data, and each class of data has K data instances (namely, first samples). Each Query Set includes Q pieces of unannotated data (namely, the to-be-processed text), and the Q pieces of data certainly belong to the N classes provided by the Support Set. A task of a Few-shot Learning Model is to predict the data in the Query Set.

Optionally, in a possible implementation mode of this embodiment, in 101, how to obtain the initial feature vector of the to-be-processed text is described in detail by specifically taking a convolutional neural network as the first neural network.

(1) Convert the Text into a Matrix

Words (e.g., M words) in the text are converted into respective D-dimensional vectors, each text will form a corresponding text matrix, and the dimensions are (D, M),

(2) The Convolutional Neural Network Extracts Features

The text matrix with the dimensions (D, M) is taken as an input, and input to the convolutional neural network, and a new matrix with dimensions (H, M) is output after passing through a convolution layer of the convolutional neural network. The convolutional layer consists of H convolution kernels. Then, new matrix goes through a pooling layer of the convolutional neural network, and 1-dimensional feature vector with a length H, namely, the initial feature vector of the text, is output.

Optionally, in a possible implementation mode of this embodiment, in 102, a result of the performed segmentation process may specifically include but not limited to a Head Entity, a Tail Entity and a Middle Mention. This is not limited in this embodiment.

The Middle Mention may include hut not limited to content between the Head Entity and the Tail Entity. This is not limited in this embodiment.

Furthermore, the result of the segmentation process may further include but not limited to at least one of a Front Mention and a Back Mention. This is not limited in this embodiment.

The Front Mention may include but not limited to content before the Head Entity. This is not particularly limited in this embodiment.

The Back Mention may include but not limited to content after the Tail Entity. This is not particularly limited in this embodiment.

For example, what is exemplified in the following table is a result of the segmentation process of the text “Under instructions the first Jesuits to be sent, Parsons and Edmund Campion, were to work closely with other Catholic priests in England.”

Segmentation process
Text
Under instructions the first Jesuits to be sent, Parsons and Edmund
Campion, were to work closely with other Catholic priests in England.

| Head | | | Middle | Back |
|---|---|---|---|---|
| Entity | Tail Entity | Front Mention | Mention | Mention |
| “Edmund | “Catholic” | “Under | “, were to | “priests in |
| Campion” | | instructions | work closely | England.” |
| | | the first | with other” | |
| | | Jesuits to be | | |
| | | sent, Parsons | | |
| | | and” | | |

Optionally, in a possible implementation mode of this embodiment, in 103, it is specifically possible to take each segment of the text as an input individually, and input said each segment to the respective second neural network for feature extraction to obtain the feature vector of each segment of the text. These second neural networks may be neural networks with the same structure or neural networks with different structures, and similarly, their parameters may be the same or different. This is not particularly limited in this embodiment.

Specifically, the structure of each second neural network may be the same as or different from that of the first neural network, and similarly, its parameters may be the same as or different from those of the first neural network. Therefore, as for detailed depictions of how to obtain the feature vector of each segment of the text, please refer to the above content about how to obtain the initial feature vector of the to-be-processed text.

Optionally, in a possible implementation mode of this embodiment, in 104, it is specifically feasible to perform a splicing process for the initial feature vector of the text and the feature vector of each segment of the text, for example, use a vector splicing principle to obtain the optimized feature vector of the text.

Optionally, in a possible implementation mode of this embodiment, an operation of obtaining the optimized feature vector of each first entity relationship class in the at least two first entity relationship classes may be further performed before 105.

First, it is possible to perform the feature extraction process on each first sample under said each first entity relationship class by using the first neural network, to obtain the initial feature vector of said each first sample.

Specifically, reference may be made to the content on how to obtain the initial feature vector of the to-be-processed text for detailed depictions of how to obtain the initial feature vector of said each first sample.

While obtaining the initial feature vector of said each first sample, it is further feasible to perform a segmentation process on said each first sample to obtain at least two segments of said each first sample, and to perform the feature extraction process on each segment in at least two segments of said each first sample by using said at least one second neural network, to obtain the feature vector of each segment of said each first sample.

A result of the performed segmentation process may specifically include but not limited to a Head Entity, a Tail Entity and a Middle Mention. The Middle Mention may include content between the Head Entity and the Tail Entity.

Furthermore, the result of the segmentation process may further include at least one of a Front Mention and a Back Mention. The Front Mention may include content before the Head Entity, and the Back Mention may include content after the Tail Entity.

Specifically, reference may be made to the content on how to obtain the feature vector of each segment of the text for detailed depictions of how to obtain the feature vector of each segment of each first sample.

After the feature vector of each segment of each first sample is obtained, the optimized feature vector of said each first sample may be obtained according to the initial feature vector of said each first sample and the feature vector of each segment of said each first sample.

Specifically, it is specifically feasible to perform a splicing process for the initial feature vector of said each first sample and the feature vector of each segment of said each first sample, for example, use a vector splicing principle to obtain the optimized feature vector of said each first sample.

After the optimized feature vector of said each first sample is obtained, the optimized feature vector of said each first entity relationship class may be obtained according to the optimized feature vector of said each first sample. Specifically, an average value of the optimized feature vectors of all first samples under said each first entity relationship class may be specifically taken as the optimized feature vector of the first entity relationship class.

Optionally, in a possible implementation mode of this embodiment, it is further possible to use each of second samples under at least two second entity relationship classes to perform a model training process to obtain the first neural network, the at least one second neural network and the third neural network.

Specifically, during the model training, it is specifically possible to, based on said each second sample, use at least one of a cross entropy loss function and a triple loss function to perform a parameter optimization process on the first neural network, the at least one second neural network and the third neural network.

In a specific implementation process, it is specifically possible to use a cross entropy loss function to perform minimized constraint on a difference between a predicted entity relationship class for each of the second samples under said each second entity relationship class and the entity relationship class annotated in the second sample.

Specifically; the cross entropy loss function may be calculated with the following equation:

$$CrossEntropyLoss = - {\sum }_{n = 1}^{c} {y}_{n} * log ( {s}_{n} )$$

where c is the number of classes of the second entity relationship class; yₙ is an annotated feature vector for the second entity relationship class; sₙ is a softmax function corresponding to a distance value between the optimized feature vector of each second sample and the optimized feature vector for the second entity relationship class to which the second sample belongs.

During model training, it is specifically possible to use the first neural network to perform a feature extraction process on each of second samples under said each second entity relationship class, to obtain the initial feature vector of said each of the second samples.

Specifically, reference may be made to the content on how to obtain the initial feature vector of the to-be-processed text for detailed depictions of how to obtain the initial feature vector of said each second sample.

While obtaining the initial feature vector of said each of the second samples, it is further possible to perform a segmentation process on each of the second samples under each second entity relationship class to obtain at least two segments of said each of second samples, and use said at least one second neural network to perform a feature extraction process on each segment in at least two segments of said each of second samples to obtain the feature vector of each segment of said each of the second samples.

Reference may be made to the content on how to obtain the feature vector of each segment for detailed depictions of how to obtain the feature vector of each segment of each second sample.

After obtaining the feature vector of each segment of each second sample, the optimized feature vector of said each second sample may be obtained according to the initial feature vector of said each second sample and the feature vector of each segment of said each second sample,

It is specifically feasible to perform a splicing process for the initial feature vector of said each second sample and the feature vector of each segment of said each second sample, for example, use a vector splicing principle to obtain an optimized feature vector of said each second sample.

After obtaining the optimized feature vector of said each second sample, an optimized feature vector of said each second entity relationship class may be obtained according to the optimized feature vector of said each second sample.

Specifically, an average value of the optimized feature vectors of all second samples under said each second entity relationship class may be specifically taken as the optimized feature vector of the second entity relationship class.

So far, it is feasible to calculate a distance value between the optimized feature vector of the second sample and the optimized feature vector of the second entity relationship class to which the second sample belongs, according to the optimized feature vector of each second sample and the optimized feature vector of the second entity relationship class to which the second sample belongs, and thereby obtain a softmax function corresponding to the distance value.

As such, the model is enabled to reach the highest recognition accuracy performing reverse transmission with a purpose of minimizing a cross entropy function.

In another specific implementation process, a triple loss function may be specifically used to constrain a difference between a first distance between an optimized feature vector of an anchor sample in each triple in at least one triple and an optimized feature vector of a positive sample in the triple, and a second distance between the optimized feature vector of the anchor sample and an optimized feature vector of a negative sample in the triple. Said each triple consists of an anchor sample, a positive sample and a negative sample, the samples in said each triple are extracted from samples in each second entity relationship class in at least two second entity relationship classes, the entity relationship class existing in the anchor sample is the same as the entity relationship class existing in the positive sample, and the entity relationship class existing in the anchor sample is different from the entity relationship class existing in the negative sample.

Reference may be made to the content about the optimized feature vector of the first sample for a method of obtaining the optimized feature vector aᵢ of the anchor sample, the optimized feature vector pᵢ of the positive sample and the optimized feature vector nᵢ of the negative sample.

Specifically, as for a single triple, its triple loss function may be calculated in the following manner:

SingleTripletLoss=max (0,∥aᵢ−pᵢ∥²−∥aᵢ−nᵢ∥²+margin)

where margin is a preset constant term; ∥aᵢ−pᵢ∥² is the first distance between the optimized feature vector of the anchor sample in the i^{th} triple and the optimized feature vector of the positive sample in the triple; ∥aᵢ−nᵢ∥² is the second distance between the optimized feature vector of the anchor sample in the triple and the optimized feature vector of the negative sample in the triple.

As for all triples for example m triples, a sum of their triple loss functions may be calculated in the following manner:

$$TripletLoss = {\sum }_{i = 1}^{m} max ( 0 , {‖ {a}_{i} - {p}_{i} ‖}^{2} - {‖ {a}_{i} - {n}_{i} ‖}^{2} + margin )$$

As such, through inter-class distribution optimization aiming to minimize the triple loss function, an intra-class distance (namely, the distance between the optimized feature vector of the anchor sample and the optimized feature vector of the positive sample) in each triple is made smaller than an inter-class distance (the distance between the optimized feature vector of the anchor sample and the optimized feature vector of the negative sample) by a remarkable distance (e.g., a preset constant term such as a margin value), so that the triple loss function generates a three between the same class of feature vectors and generates a pushing force between different classes of feature vectors, thereby making the inter-class feature distribution of the model more uniform and the intra-class feature distribution more compact.

In another specific implementation process, it is specifically possible to use a cross entropy loss function to perform minimized constraint on a difference between the predicted entity relationship class for each second sample under said each second entity relationship class and the entity relationship class annotated in the second sample; and use a triple loss function to constrain a difference between a first distance between an optimized feature vector of an anchor sample in each triple in at least one triple and an optimized feature vector of a positive sample in the triple, and a second distance between the optimized feature vector of the anchor sample and an optimized feature vector of a negative sample in the triple; where said each triple consists of the anchor sample, the positive sample and the negative sample, the samples in said each triple are extracted from samples under each second entity relationship class in at least two second entity relationship classes, the entity relationship class existing in the anchor sample is the same as the entity relationship class existing in the positive sample, and the entity relationship class existing in the anchor sample is different from the entity relationship class existing in the negative sample.

Since a classification effect of the model is produced based on the inter-class distribution of the feature vectors, the inter-class is optimized, so that the distance contrast of the features of the to-be-processed text and the features of the entity relationship class produces a clearer classification effect.

To enable the triple loss function to jointly work with the cross entropy loss function to produce a better model optimization effect, it is further feasible to calculate a weighted sum of two kinds of functions to produce a final loss function.

FIG. 1B is a schematic diagram of a classification effect of using a cross entropy loss function for model training in an embodiment corresponding to FIG. 1; FIG. 1C is a schematic diagram of a classification effect of using a cross entropy loss function and a triple loss function to perform model training in the embodiment corresponding to FIG. 1. It may be found by comparing the two classification effect schematic diagrams that the inter-class feature distribution of FIG. 1C is more uniform and the intra-class feature distribution is more compact.

In this embodiment, it is feasible to perform a feature extraction process on a to-be-processed text with a first neural network, to obtain an initial feature vector of the text, then perform a segmentation process on the text to obtain at least two segments of the text, then perform a feature extraction process for each segment of the at least two segments of the text by using at least one second neural network, to obtain a feature vector of each segment of the text, and then obtain an optimized feature vector of the text according to the initial feature vector of the text and the feature vector of each segment of the text, so that it is possible to according to an optimized feature vector of each first entity relationship class in at least two first entity relationship classes and the optimized feature vector of the text, obtain the first entity relationship class existing in the text by using the third neural network. Since a small amount of annotated data, namely, a small amount of annotated samples under some uncommon entity relationship classes are used, and segment features with a finer granularity are increased to characterize the to-be-processed text, it is possible to, based on the small amount of annotated samples of uncommon entity relationships, accurately predict uncommon entity relationships existing in the text, and thereby improve the recognition accuracy of the small amount of uncommon entity relationships.

In addition, the technical solution according to the present disclosure need not depend on a large amount of annotated samples of the uncommon entity relationships, so that the costs of the annotated data may be substantially reduced upon model training, and meanwhile the stability of the model be ensured.

In addition, with the technical solution according to the present disclosure, the recognition accuracy may be further improved by introducing the additional triple loss function in addition to the cross entropy loss function in the model training phase.

In addition, the user's experience may be effectively improved according to the technical solution of the present disclosure.

It is to be noted that, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

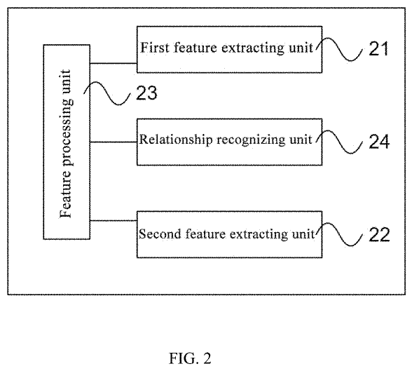

FIG. 2 is a structural schematic diagram of an entity relationship processing apparatus according to an embodiment of the present disclosure. As shown in FIG. 2, the entity relationship processing apparatus of this embodiment may include a first feature extracting unit 21, a second feature extracting unit 22, a feature processing unit 23 and a relationship recognizing unit 24. The first feature extracting unit 21 is configured to perform a feature extraction process on a to-be-processed text by using a first neural network, to obtain an initial feature vector of the text. The second feature extracting unit 22 is configured to perform a segmentation process on the text to obtain at least two segments of the text, and perform a feature extraction process for each segment of the at least two segments of the text by using at least one second neural network, to obtain a feature vector of each segment of the text. The feature processing unit 23 is configured to obtain an optimized feature vector of the text according to the initial feature vector of the text and the feature vector of each segment of the text. The relationship recognizing unit 24 is configured to, according to an optimized feature vector of each first entity relationship class in at least two first entity relationship classes and the optimized feature vector of the text, obtain the first entity relationship class existing in the text by using a third neural network.

It is to be noted that the entity relationship processing apparatus may partially or totally be an application located in a local terminal, or a function unit such as a plug-in or Software Development Kit (SDK) located in an application of the local terminal, or a processing engine located in a network-side server, or a distributed type system located on the network side. This is not particularly limited in this embodiment.

It may be understood that the application may be a native application (native APP) installed on the terminal, or a web program (webApp) of a browser on the terminal. This is not particularly limited in this embodiment.

Optionally, in a possible implementation of this embodiment, the relationship recognizing unit 24 may further be configured to use the first neural network to perform a feature extraction process on each first sample under said each first entity relationship class, to obtain an initial feature vector of said each first sample; perform a segmentation process on said each first sample to obtain at least two segments of said each first sample; use said at least one second neural network to perform the feature extraction process on each segment in at least two segments of said each first sample, to obtain a feature vector of each segment of said each first sample; obtain an optimized feature vector of said each first sample according to the initial feature vector of said each first sample and the feature vector of each segment of said each first sample; and obtain an optimized feature vector of said each first entity relationship class according to the optimized feature vector of said each first sample.

Optionally, in a possible implementation of this embodiment, a result of the segmentation process involved in this embodiment may include but not limited to a Head Entity, a Tail Entity and a Middle Mention, wherein the Middle Mention may include but not limited to content between the Head Entity and the Tail Entity. This is not particularly limited in this embodiment.

Furthermore, the result of the segmentation process may further include at least one of a Front Mention and a Back Mention. The Front Mention may include but not limited to content before the Head Entity, and the Back Mention may include but not limited to content after the Tail Entity. This is not particularly limited in this embodiment.

Optionally, in a possible implementation of this embodiment, the relationship recognizing unit 24 may be further configured to use each second sample under at least two second entity relationship classes to perform a model training process to obtain the first neural network, the at least one second neural network and the third neural network.

Specifically, the relationship recognizing unit 24 may be specifically configured to use at least one of a cross entropy loss function and a triple loss function to perform a parameter optimization process on the first neural network, the at least one second neural network and the third neural network.

In a specific implementation, the relationship recognizing unit 24 may be specifically configured to use a cross entropy loss function to perform minimized constraint on a difference between a predicted entity relationship class in each second sample under said each second entity relationship class and the entity relationship class annotated in the second sample.

In another specific implementation, the relationship recognizing unit 24 may be specifically configured to use a triple loss function to constrain a difference between a first distance between an optimized feature vector of an anchor sample in each triple in at least one triple and an optimized feature vector of a positive sample in the triple, and a second distance between the optimized feature vector of the anchor sample and an optimized feature vector of a negative sample in the triple. Said each triple consists of an anchor sample, a positive sample and a negative sample, the samples in said each triple are extracted from samples in each second entity relationship class in at least two second entity relationship classes, the entity relationship class existing in the anchor sample is the same as the entity relationship class existing in the positive sample, and the entity relationship class existing in the anchor sample is different from the entity relationship class existing in the negative sample.

In another specific implementation, the relationship recognizing unit 24 may be specifically configured to use a cross entropy loss function to perform minimized constraint on a difference between a predicted entity relationship class in each second sample under said each second entity relationship class and the entity relationship class annotated in the second sample; and use a triple loss function to constrain a difference between a first distance between an optimized feature vector of an anchor sample in each triple in at least one triple and an optimized feature vector of a positive sample in the triple, and a second distance between the optimized feature vector of the anchor sample and an optimized feature vector of a negative sample in the triple. Said each triple consists of an anchor sample, a positive sample and a negative sample, the samples in said each triple are extracted from samples in each second entity relationship class in at least two second entity relationship classes. The entity relationship class existing in the anchor sample is the same as the entity relationship class existing in the positive sample, and the entity relationship class existing in the anchor sample is different from the entity relationship class existing in the negative sample.

It is to be noted that the method in the embodiment corresponding to FIG. 1A may be implemented by the entity relationship processing apparatus of this embodiment. For detailed depictions, please refer to relevant content in the embodiment corresponding to FIG. 1A, and detailed depictions will not be presented here.

In this embodiment, the first feature extracting unit performs a feature extraction process on a to-be-processed text by using a first neural network, to obtain an initial feature vector of the text, then the second feature extracting unit performs a segmentation process on the text to obtain at least two segments of the text, then performs a feature extraction process for each segment of the at least two segments of the text by using at least one second neural network, to obtain a feature vector of each segment of the text, and then the feature processing unit obtains an optimized feature vector of the text according to the initial feature vector of the text and the feature vector of each segment of the text, so that the relationship recognizing unit, according to an optimized feature vector of each first entity relationship class in at least two first entity relationship classes and the optimized feature vector of the text, obtain the first entity relationship class existing in the text with the third neural network. Since a small amount of annotated data, namely, a small amount of annotated samples under some uncommon entity relationship classes are used, and segment features with a finer granularity are increased to characterize the to-be-processed text, it is possible to, based on the small amount of annotated samples of uncommon entity relationships, accurately predict uncommon entity relationships existing in the text, and thereby improve the recognition accuracy of the small amount of uncommon entity relationships.

In addition, the technical solution according to the present disclosure does not depend on a large amount of annotated samples of the uncommon entity relationships, so that the costs of the annotated data may be substantially reduced upon model training, and meanwhile the stability of the model may be ensured.

In addition, with the technical solution according to the present disclosure, the recognition accuracy may be further improved by introducing the additional triple loss function in addition to the cross entropy loss function in the model training phase.

In addition, the user's experience may be effectively improved according to the technical solution of the present disclosure.

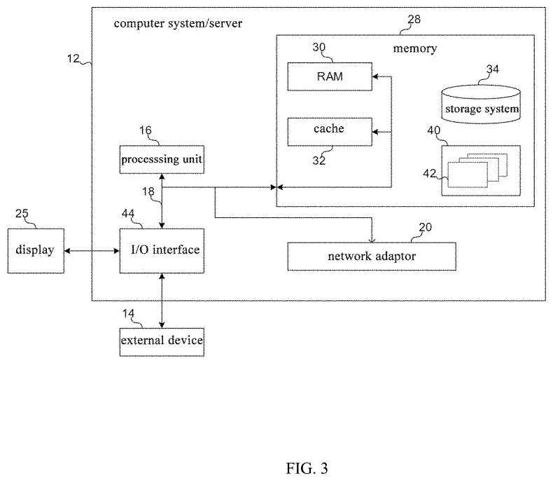

FIG. 3 illustrates a block diagram of an example computer system/server 12 adapted to implement an implementation mode of the present disclosure. The computer system/server 12 shown in FIG. 3 is only an example and should not bring about any limitation to the function and scope of use of the embodiments of the present disclosure.

As shown in FIG. 3, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 3 and typically called a “hard drive”). Although not shown in FIG. 3, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 3, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the entity relationship processing method provided by the embodiment corresponding to FIG. 1A,

Another embodiment of the present disclosure further provides a computer-readable storage medium on which a computer program is stored. The program, when executed by a processor, can implement the entity relationship processing method provided by the embodiment corresponding to FIG. 1A.

Specifically, the computer-readable medium of this embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseboard or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may he made to an external computer (for example, through the Internet using an Internet Service Provider).

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms,

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs,

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc. or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. An entity relationship processing method, comprising:
performing a feature extraction process on a to-be-processed text by using a first neural network, to obtain an initial feature vector of the text;
performing a segmentation process on the text to obtain at least two segments of the text;
performing a feature extraction process on each segment of the at least two segments of the text by using at least one second neural network, to obtain a feature vector of each segment of the text;
obtaining an optimized feature vector of the text according to the initial feature vector of the text and the feature vector of each segment of the text; and
obtaining a first entity relationship class existing in the text by using a third neural network, according to an optimized feature vector for each first entity relationship class in at least two first entity relationship classes and the optimized feature vector of the text.

2. The method according to claim 1, further comprising:
before obtaining the first entity relationship class existing in the text by using the third neural network, according, to the optimized feature vector of each first entity relationship class in at least two first entity relationship classes and the optimized feature vector of the text, performing a feature extraction process on each first sample under said each first entity relationship class by using the first neural network, to obtain an initial feature vector of said each first sample;
performing a segmentation process on said each first sample to obtain at least two segments of said each first sample;
performing a feature extraction process on each segment of at least two segments of said each first sample by using said at least one second neural network, to obtain a feature vector of each segment of said each first sample;
obtaining an optimized feature vector of said each first sample according to the initial feature vector of said each first sample and the feature vector of each segment of said each first sample; and
obtaining the optimized feature vector for said each first entity relationship class according to the optimized feature vector of said each first sample.

3. The method according to claim 1, wherein a result of the segmentation process comprises a Head Entity, a Tail Entity and a Middle Mention, wherein the Middle Mention comprises content between the Head Entity and the Tail Entity.

4. The method according to claim 3, wherein the result of the segmentation process further comprises at least one of a Front Mention and a Back Mention, wherein the Front Mention comprises content before the Head Entity, and the Back Mention comprises content after the Tail Entity.

5. The method according to claim 1, further comprising:
using each of second samples under at least two second entity relationship classes to perform a model training process to obtain the first neural network, the at least one second neural network and the third neural network.

6. The method according to claim 5, wherein using each of the second samples under at least two second entity relationship classes to perform the model training process comprises:
using at least one of a cross entropy loss function and a triple loss function to perform a parameter optimization process on the first neural network, the at least one second neural network and the third neural network.

7. The method according to claim 6, wherein using the cross entropy loss function to perform the parameter optimization process on the first neural network, the at least one second neural network and the third neural network comprises:
using the cross entropy loss function to perform minimized constraint on a difference between a predicted entity relationship class for each of the second samples under said each second entity relationship class and an entity relationship class annotated in the second sample.

8. The method according to claim 6, wherein using the triple loss function to perform the parameter optimization process on the first neural network, the at least one second neural network and the third neural network comprises:
using the triple loss function to constrain a difference between a first distance and a second distance, wherein the first distance is a distance between an optimized feature vector of an anchor sample in each triple in at least one triple and an optimized feature vector of a positive sample in the triple, and the second distance is a distance between the optimized feature vector of the anchor sample and an optimized feature vector of a negative sample in the triple; and wherein said each triple consists of the anchor sample, the positive sample and the negative sample, which are extracted from samples under each second entity relationship class in at least two second entity relationship classes, wherein an entity relationship class existing in the anchor sample is the same as an entity relationship class existing in the positive sample, and the entity relationship class existing in the anchor sample is different from an entity relationship class existing in the negative sample.

9, The method according to claim 6, wherein using at least one of the cross entropy loss function and the triple loss function to perform the parameter optimization process on the first neural network, the at least one second neural network and the third neural network comprises:
using the cross entropy loss function to perform minimized constraint on a difference between a predicted entity relationship class for each of the second samples under said each second entity relationship class and an entity relationship class annotated in the second sample; and
using the triple loss function to constrain a difference between a first distance and a second distance, wherein the first distance is a distance between an optimized feature vector of an anchor sample in each triple in at least one triple and an optimized feature vector of a positive sample in the triple, and the second distance is a distance between the optimized feature vector of the anchor sample and an optimized feature vector of a negative sample in the triple; and wherein said each triple consists of the anchor sample, the positive sample and the negative sample, which are extracted from samples under each second entity relationship class in at least two second entity relationship classes, wherein an entity relationship class existing in the anchor sample is the same as an entity relationship class existing in the positive sample, and the entity relationship class existing in the anchor sample is different from an entity relationship class existing in the negative sample.

10. A device, comprising:
one or more processors:
a storage for storing one or more programs,
the one or more programs, when executed by said one or more processors, enable said one or more processors to implement an entity relationship processing method, which comprises:
performing a feature extraction process on a to-be-processed text by using a first neural network, to obtain an initial feature vector of the text;
performing a segmentation process on the text to obtain at least two segments of the text;
performing a feature extraction process on each segment of the at least two segments of the text by using at least one second neural network, to obtain a feature vector of each segment of the text;
obtaining an optimized feature vector of the text according to the initial feature vector of the text and the feature vector of each segment of the text; and
obtaining a first entity relationship class existing in the text by using a third neural network, according to an optimized feature vector for each first entity relationship class in at least two first entity relationship classes and the optimized feature vector of the text.

11. The device according to claim 10, wherein the method further comprises:
before obtaining the first entity relationship class existing in the text by using the third neural network, according to the optimized feature vector of each first entity relationship class in at least two first entity relationship classes and the optimized feature vector of the text,
performing a feature extraction process on each first sample under said each first entity relationship class by using the first neural network, to obtain an initial feature vector of said each first sample;
performing a segmentation process on said each first sample to obtain at least two segments of said each first sample;
performing a feature extraction process on each segment of at least two segments of said each first sample by using said at least one second neural network, to obtain a feature vector of each segment of said each first sample;
obtaining an optimized feature vector of said each first sample according to the initial feature vector of said each first sample and the feature vector of each segment of said each first sample; and
obtaining the optimized feature vector for said each first entity relationship class according to the optimized feature vector of said each first sample.

12. The device according to claim 10, wherein the method further comprises:
using each of second samples under at least two second entity relationship classes to perform a model training process to obtain the first neural network, the at least one second neural network and the third neural network.

13. The device according to claim 12, wherein using each of the second samples under at least two second entity relationship classes to perform the model training process comprises:
using at least one of a cross entropy loss function and a triple loss function to perform a parameter optimization process on the first neural network, the at least one second neural network and the third neural network.

14. The device according to claim 13, wherein using the cross entropy loss function to perform the parameter optimization process on the first neural network, the at least one second neural network and the third neural network comprises:
using the cross entropy loss function to perform minimized constraint on a difference between a predicted entity relationship class for each of the second samples under said each second entity relationship class and an entity relationship class annotated in the second sample.

15. The device according to claim 14, wherein using the triple loss function to perform the parameter optimization process on the first neural network, the at least one second neural network and the third neural network comprises:
using the triple loss function to constrain a difference between a first distance and a second distance, wherein the first distance is a distance between an optimized feature vector of an anchor sample in each triple in at least one triple and an optimized feature vector of a positive sample in the triple, and the second distance is a distance between the optimized feature vector of the anchor sample and an optimized feature vector of a negative sample in the triple; and wherein said each triple consists of the anchor sample, the positive sample and the negative sample, which are extracted from samples under each second entity relationship class in at least two second entity relationship classes, wherein an entity relationship class existing in the anchor sample is the same as an entity relationship class existing in the positive sample, and the entity relationship class existing in the anchor sample is different from an entity relationship class existing in the negative sample.

16. A non-transitory computer readable storage medium on which a computer program is stored, wherein the program, when executed by a processor, implements an entity relationship processing method, which comprises:
performing a feature extraction process on a to-be-processed text by using a first neural network, to obtain an initial feature vector of the text;
performing a segmentation process on the text to obtain at least two segments of the text;
performing a feature extraction process on each segment of the at least two segments of the text by using at least one second neural network, to obtain a feature vector of each segment of the text;
obtaining an optimized feature vector of the text according to the initial feature vector of the text and the feature vector of each segment of the text; and
obtaining a first entity relationship class existing in the text by using a third neural network, according to an optimized feature vector for each first entity relationship class in at least two first entity relationship classes and the optimized feature vector of the text.

17. The non-transitory computer readable storage medium according to claim 16, wherein the method further comprises:
before obtaining the first entity relationship class existing in the text by using the third neural network, according to the optimized feature vector of each first entity relationship class in at least two first entity relationship classes and the optimized feature vector of the text,
performing a feature extraction process on each first sample under said each first entity relationship class by using the first neural network, to obtain an initial feature vector of said each first sample;
performing a segmentation process on said each first sample to obtain at least two segments of said each first sample;
performing a feature extraction process on each segment of at least two segments of said each first sample by using said at least one second neural network, to obtain a feature vector of each segment of said each first sample;
obtaining an optimized feature vector of said each first sample according to the initial feature vector of said each first sample and the feature vector of each segment of said each first sample; and
obtaining the optimized feature vector for said each first entity relationship class according to the optimized feature vector of said each first sample.

18. The non-transitory computer readable storage medium according to claim 16, wherein the method further comprises:
using each of second samples under at least two second entity relationship classes to perform a model training process to obtain the first neural network, the at least one second neural network and the third neural network.

19. The non-transitory computer readable storage medium according to claim 18, wherein using each of the second samples under at least two second entity relationship classes to perform the model training process comprises:
using at least one of a cross entropy loss function and a triple loss function to perform a parameter optimization process on the first neural network, the at least one second neural network and the third neural network.

20. The non-transitory computer readable storage medium according to claim 19, wherein using the cross entropy loss function to perform the parameter optimization process on the first neural network, the at least one second neural network and the third neural network comprises:
using the cross entropy loss function to perform minimized constraint on a difference between a predicted entity relationship class for each of the second samples under said each second entity relationship class and an entity relationship class annotated in the second sample; and
wherein using the triple loss function to perform the parameter optimization process on the first neural network, the at least one second neural network and the third neural network comprises:
using the triple loss function to constrain a difference between a first distance and a second distance, wherein the first distance is a distance between an optimized feature vector of an anchor sample in each triple in at least one triple and an optimized feature vector of a positive sample in the triple, and the second distance is a distance between the optimized feature vector of the anchor sample and an optimized feature vector of a negative sample in the triple; and wherein said each triple consists of the anchor sample, the positive sample and the negative sample, which are extracted from samples under each second entity relationship class in at least two second entity relationship classes, wherein an entity relationship class existing in the anchor sample is the same as an entity relationship class existing in the positive sample, and the entity relationship class existing in the anchor sample is different from an entity relationship class existing in the negative sample.
